(19) United States
(12) Patent Application Publication
(10) Pub. No.: US 2015/0308973 A1
(43) Pub. Date: Oct. 29, 2015

(54) METHODS AND APPARATUS FOR MEASURING ELECTRICAL PROPERTIES OF CELLS

(71) Applicant: Rhode Island Board of Education, State of Rhode Island and Providence Plantations, Providence, RI (US)

(72) Inventors: Ying Sun, West Warwick, RI (US); Charles Scouten, Downers Grove, IL (US)

(21) Appl. No.: 14/693,022

(22) Filed: Apr. 22, 2015

Related U.S. Application Data
(60) Provisional application No. 61/984,240, filed on Apr. 25, 2014.

(51) Int. Cl. G01N 27/22

(52) U.S. Cl. CPC G01N 27/22

(57) ABSTRACT

A method and an apparatus are disclosed for measuring the electrical properties of biological cells. The method involves a switching excitation with a sinusoidally amplitude-modulated current coupled with a real-time estimation algorithm for extracting a phase-shifted sinusoidal voltage output. The algorithm uses a unique time-domain formulation that provides accurate and continuous measurements with a high temporal resolution. The invention is suitable for measuring small signals under noisy conditions such as the membrane resistance and capacitance of a living cell accessed via a microelectrode. The resulting apparatus achieves a similar effect of a lock-in amplifier for suppressing noise but with a different approach. The invention also has the advantage that the input and the output can be decoupled by time-multiplexing on a single electrode.

### PRIORITY

The present application claims priority to U.S. Provisional Patent Application Ser. No. 61/984,240 filed Apr. 25, 2014, the disclosure of which is hereby incorporated by reference in its entirety.

### BACKGROUND

This present invention addresses the need for a means to monitor cell capacitance accurately and continuously. A cell membrane consists of the lipid bilayer that has a fairly constant specific capacitance (0.9 μF/cm²). Thus, the cell capacitance is generally proportional to the cell surface area. Monitoring the cell capacitance can reveal changes of the cell surface area. Exocytosis is the secretion process that the cell directs the contents of a vesicle to the extracellular space. Conversely, endocytosis is the process that the cell takes in substances from outside via vesicle formation and transport. The mergence of a vesicle into the cell membrane momentarily increases the cell surface area, thereby changing the cell capacitance. The whole cell capacitance is typically 3˜12 pF (pico=10⁻¹²). The capacitance signal from a single vesicle is typically 1˜15 fF (femto=10⁻¹⁵), about 1/1000 of the whole cell capacitance.

The condition for measuring the cell capacitance is of a very low signal-to-noise ratio. The capacitance signals related to vesicle activities are very small to begin with. The resistance of the microelectrode used to access the cell is in the mega-ohm range, which is susceptible to noise. A lock-in amplifier is often required to improve the signal-to-noise ratio by modulating the excitations with sinusoidal waveforms. However, the typical lock-in amplifier is a two-port system, i.e. one port for excitation and the other port for induced response; it cannot be integrated seamlessly with a patch clamp amplifier that accesses a cell via a single microelectrode.

Recent studies have shown the possibility of measuring the vesicle capacitance signal. For example, Rituper et al. (Nature Protocols 8:169-83, 2013) developed a system based on a lock-in amplifier to measure the admittance of the cell, consisting of a real part (conductance) and an imaginary part (susceptance). Rituper et al. were able to obtain susceptance pulses related to vesicle discharges. However, both their instrumentation and computational method as well as similar systems used by other researchers were complicated and incapable of tracking fast vesicle activities in real time.

The standard electrical model of the cell membrane consists of three elements. An access resistance (Rₐ) represents the microelectrode used to access the cell. A resistance (Rₘ) in parallel with a capacitance (Cₘ) represents the cell membrane. The methods for estimating these electrical properties reported in literature have been formulated in the frequency domain. The admittance of the three-element model is expressed as a function of the angular frequency co as shown below (Lempka & Barnett, IEEE EMBS Conference 2004):

$$Y ( ω ) = \frac{1 + {ω}^{2} {R}_{m} {R}_{p} {C}_{m}^{2}}{{R}_{T} ( 1 + {ω}^{2} {R}_{p}^{2} {C}_{m}^{2} )} + j \frac{ω {R}_{m}^{2} {C}_{m}}{{R}_{T}^{2} ( 1 + {ω}^{2} {R}_{p}^{2} {C}_{m}^{2} )} , \qquad ( 1 )$$

where R_{T}=Rₐ+Rₘ and Rₚ=Rₐ*Rₘ/R_{T}. Equation (1) is relatively complicated and highly nonlinear. In order to identify the three model elements, measurements need to be obtained at multiple frequencies. Furthermore, a nonlinear estimation method is needed. For example, Barnett and Misler (Biophys J 72:1641-58, 1997) reported the use of dual-frequency excitation and a nonlinear least-squares estimation method to measure the cell capacitance. A nonlinear estimation method is always iterative in nature, which has relatively long and variable execution time. Thus, the resulting systems are not suitable for fast, real-time monitoring of vesicle activities.

The concept of the lock-in amplifier is that when a linear system is driven by a sinusoidal excitation, its output must also be a sinusoidal signal of the same frequency. Any frequency components other than the input frequency are considered noise and can be filtered out. However, the conventional lock-in amplifier is a two-port system with the output port separated from the input port. Thus, it doesn't lend itself directly to the single-electrode setting of a patch clamp. There exist some instrumental difficulties when integrating a patch-clamp amplifier with a lock-in amplifier.

The frequency-domain approach involves a relatively complex expression for the admittance of the three-element model. The current methods using multiple-frequency excitations and nonlinear estimation techniques are awkward, non-real-time, and of a low temporal resolution. A nonlinear estimation method, such as the Newton-Raphson method or the steepest descent method, is iterative in nature. The termination condition of such method is set to render the error below a certain threshold. The number of iterations dictates the computational time, which varies and is not suitable for real-time operation. The requirement for multi-frequency excitations is another obstacle that prevents monitoring the vesicle activities with a high temporal resolution.

### SUMMARY

In accordance with an embodiment, the invention provides a method for measuring the electrical properties of a measurand via a single port comprising the steps of:

(a) calibrating the system by measuring the electrode resistance,

(b) applying a current injection of a sinusoidally amplitude-modulated switching waveform via a time-multiplexed channel to said measurand,

(c) measuring the induced voltage that is time-multiplexed with the said current from said port via said channel,

(d) estimating the magnitude and the phase of said induced voltage,

(e) forming a circuit model that represents the electrical properties and circuit topology of said measurand,

(f) deriving the time-domain equations that govern the continuity of currents of said circuit model,

(g) computing the derivatives of the injected current and the induced voltage by using closed-form sinusoidal equations,

(h) forming a linear estimator to determine the unknown electrical properties

(i) repeating the above steps in real time to achieve continuous monitoring of the electrical properties of said measurand.

In accordance with another embodiment, the invention provides an apparatus for measuring the electrical properties of a measurand via a single port comprising:

(a) means for calibrating the system by measuring the electrode resistance,

(b) means for applying a current injection of a sinusoidally amplitude-modulated switching waveform via a time-multiplexed channel to said measurand,

(c) means for measuring the induced voltage that is time-multiplexed with the said current from said port via said channel,

(d) means for estimating the magnitude and the phase of said induced voltage,

(e) means for forming a circuit model that represents the electrical properties and circuit topology of said measurand,

(f) means for deriving the time-domain equations that govern the continuity of currents of said circuit model,

(g) means for computing the derivatives of the injected current and the induced voltage by using closed-form sinusoidal equations,

(h) means for forming a linear estimator to determine the unknown electrical properties, and

(i) means for repeating the above steps in real time to achieve continuous monitoring of the electrical properties of said measurand.

### BRIEF DESCRIPTION OF THE DRAWINGS

The following description may be further understood with reference to the accompanying drawing in which:

FIG. 1 is an illustrative diagrammatic view of the system that measures electrical properties of a measurand by time-multiplexing the current injection and the voltage measurement via a single port; the measurand is modeled as a three-element circuit with a resistor in series with parallel resistor and capacitor;

FIG. 2 illustrates the switching excitation that interleaves the current injection intervals and the voltage measurement intervals in a time-multiplexed fashion;

FIG. 3A illustrates the concept of a switching excitation with sinusoidally amplitude-modulated current injection and an induced voltage that has a sinusoidal envelope with a phase shift; and FIG. 3B illustrates a non-switching sinusoidal current injection waveform with an induced sinusoidal voltage response, which is also applicable to the present invention;

FIG. 4 shows the waveforms of the injected current and the measured voltage by computer simulation (top) and from a hardware experiment (bottom); and

FIG. 5 shows a flow chart of the signal processing and estimation method.

### DETAILED DESCRIPTION

This invention provides a method and an apparatus for monitoring electrical properties of a measurand under noisy conditions with high accuracy and high temporal resolution. It overcomes the drawbacks of the existing techniques in the following three aspects.

First, the excitation (current injection) and the induced response (voltage measurement) are time-multiplexed via a single port, making it suitable for single-electrode experimental settings such as the patch clamp.

Second, the switching current injection is amplitude-modulated with a sinusoidal waveform, which encompasses the essence of a lock-in amplifier to suppress noise. When coupled with a suitable estimation algorithm, the system significantly improves the signal-to-noise ratio by accepting signals of the modulation frequency and rejecting noise of all other frequencies.

Third, a novel estimation algorithm is formulated in the time domain instead of the frequency-domain. The algorithm takes advantage of the fact that the induced response should have a phase-shifted sinusoidal waveform of the modulation frequency and the derivatives of the induced response have closed-form solutions. An accurate estimate of the electrical properties of the measurand is obtained with a non-iterative linear estimation method with data collected from one cycle of the sinusoidal excitation, thereby achieving both high accuracy and high temporal resolution.

Whereas it was initially designed to measure cell capacitances, the method has a broader range of applications for measuring electrical properties in general. The apparatus in this invention can achieve a similar effect of a lock-in amplifier for applications that require a single-port access. The method can also be extended to a two-port system and incorporated into the design of a lock-in amplifier. The estimation method is useful for applications that the observed signals are known to be sinusoidal or any analytical function with closed-form solutions of its derivatives.

In accordance with an embodiment, the present invention provides a system for measuring the electrical properties of a measurand by use of a sinusoidally amplitude-modulated switching excitation and a time-domain formulation of a linear least-squares estimator. The method encompasses the essence of a lock-in amplifier to suppress noise. The formulation of the estimator takes advantage of the fact that closed-form solutions of the time derivatives exist for an induced response with a sinusoidal waveform.

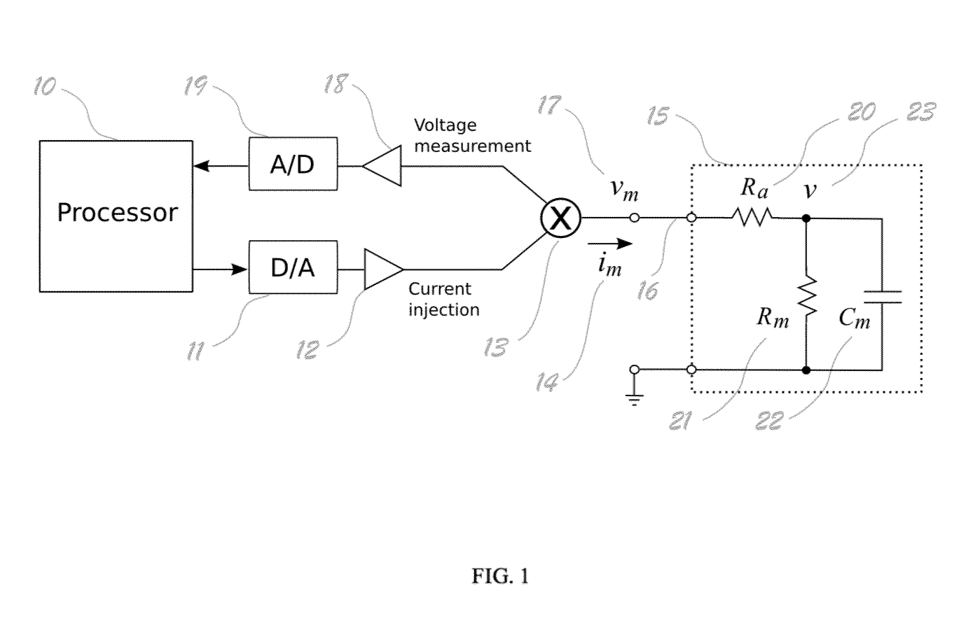

FIG. 1 shows the block diagram of the system. A processor 10 generates a sinusoidally amplitude-modulated switching excitation via a digital-to-analog converter (D/A) 11 and an amplifier 12. Via a multiplexer switch 13 the injected current (iₘ) 14 is delivered a single-port measurand 15 through a channel 16. The induced voltage (vₘ) 17 is time-multiplexed with iₘ via the multiplexer switch 13. After an amplifier stage 18, vₘ is acquired by the processor 10 via an analog-to-digital converter (A/D) 19. The measurand 15 is modeled by an electrical circuit that specifies the circuit topology and the electrical properties to be measured. The example shown in FIG. 1 is a 3-element model of the cell membrane that consists of an access resistor Rₐ 20, a membrane resistor Rₘ 21, and a membrane capacitor Cₘ 22. The voltage across the capacitor v 23 is not directly measurable, which needs to be estimated.

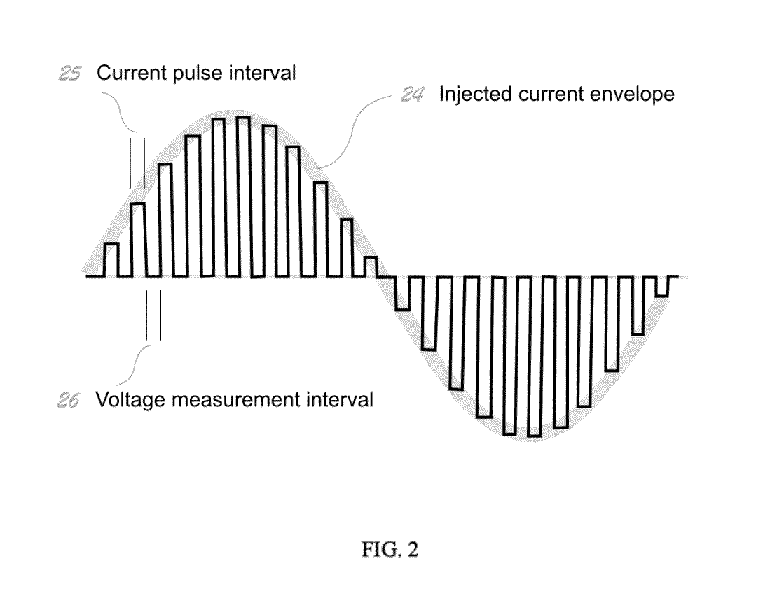

FIG. 2 shows the waveform of a switching excitation with a sinusoidal amplitude modulation 24. The current injection and the voltage measurement are time-multiplexed. Each current injection pulse is delivered during a short time interval 25. During the voltage measurement interval 26, the current is switched off and outputs a high-impedance state to avoid interference with the voltage measurement.

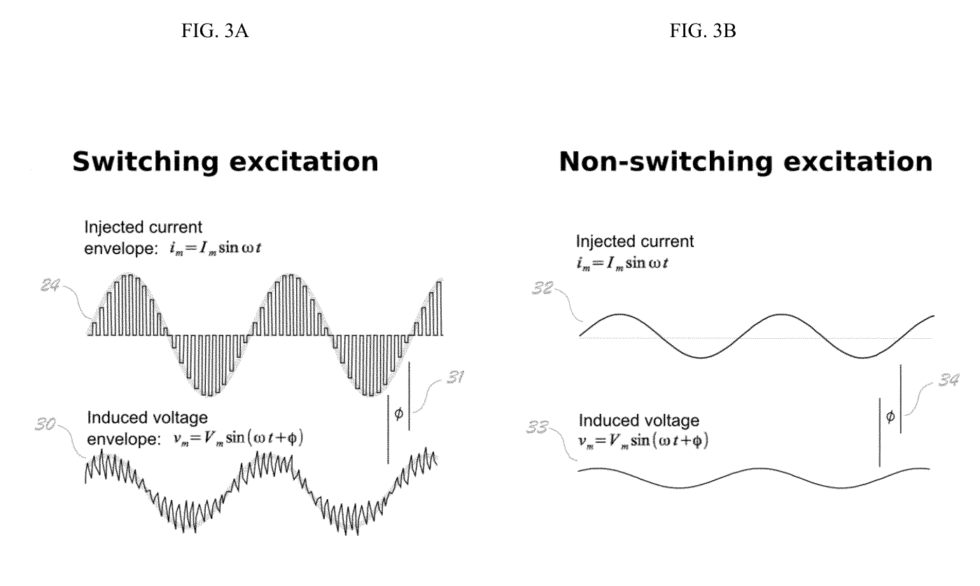

FIG. 3A shows the waveform of a switching injected current 24 that has an sinusoidal envelope given by:

iₘ=Iₘ sin ωt, (2)

where Iₘ is the magnitude of the current sine wave and the angular frequency ω=2πf. The induced voltage 30 may be contaminated with noise, but its envelope should also be a sinusoidal function with a phase shift φ 31.

vₘ=Vₘ sin(ωt+φ), (3)

where Vₘ is the magnitude of the voltage sine wave.

The switching excitation has the advantage of decoupling the current injection and voltage measurement is a time-multiplexed fashion. This allows for the use of a large-magnitude current injection without being restricted by the voltage measurement side. In other words, without the time multiplexing, a strong current injection could damage the hardware for voltage measurement. For applications involving microelectrodes a strong current injection is often required to overcome the large electrode resistance and to improve the signal-to-noise ratio.

Nevertheless, the methodology of the present invention is also applicable to a non-switching excitation as shown in FIG. 3B. As long as the magnitude of the current injection 32 is sufficiently low, it is possible to measure the induced voltage 33 and determine a phase shift φ 34.

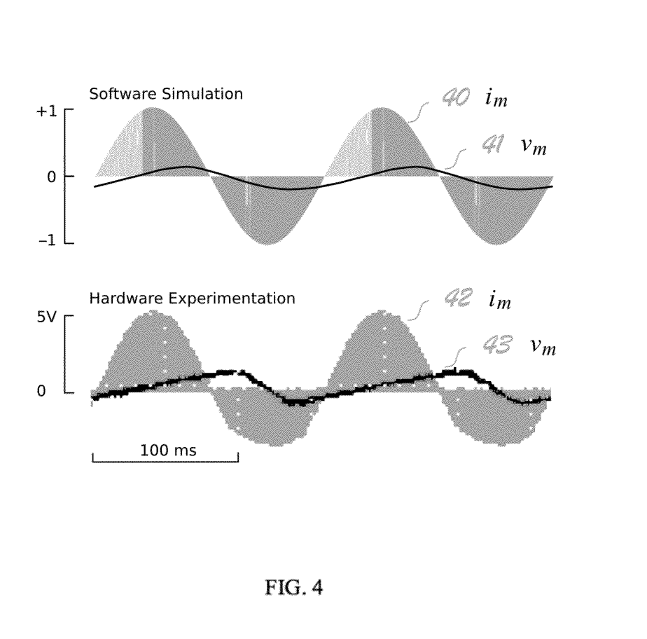

The proposed relationship between the sinusoidally amplitude-modulated switching excitation and the induced voltage was verified with both computer simulation and hardware experimentation. FIG. 4 shows the computer simulated waveforms for iₘ 40 and vₘ 41 as well as the hardware generated iₘ 42 and vₘ 43.

The circuit equations that govern the 3-element model 15 in FIG. 1 are obtained by applying the Kirchhoff's current law (continuity of current) as follows:

$${i}_{m} = {C}_{m} {v}^{′} + \frac{v}{{R}_{m}} = \frac{{v}_{m} - v}{{R}_{a}} , where {v}^{′} = \frac{d v}{d t} \qquad ( 4 )$$

The measurement process begins with a calibration step to determine the electrode resistance Rₐ.

This is accomplished with the electrode in the bath solution before in contact with the cell. From equation (4), we have

v=vₘ−Rₐiₘ (5)

By taking the derivatives on both sides of equation (5), we have

$${v}^{′} = {v}_{m}^{′} - {R}_{a} {i}_{m}^{′} , where {v}_{m}^{′} = \frac{d {v}_{m}}{d t} ; {i}_{m}^{′} = \frac{d {i}_{m}}{d t} \qquad ( 6 )$$

By substituting equations (5) and (6) into equation (4), we have

$${i}_{m} = {C}_{m} ( {v}_{m}^{′} - {R}_{a} {i}_{m}^{′} ) + \frac{1}{{R}_{m}} ( {v}_{m} - {R}_{a} {i}_{m} ) \qquad ( 7 )$$

By rearranging equation (7), we have

$${v}_{m}^{′} - {R}_{a} {i}_{m}^{′} = ( \frac{1}{{C}_{m}} + \frac{{R}_{a}}{{R}_{m} {C}_{m}} ) {i}_{m} - \frac{1}{{R}_{m} {C}_{m}} {v}_{m} \qquad ( 8 )$$

Define the derivative variable x as

x=v′ₘ−Rₐi′ₘ (9)

One of the key concepts in this invention is that a closed-form solution of the derivatives in equation (9) can be obtained from the sinusoidal inputs and outputs. In essence, the sinusoidal amplitude-modulation not only provides a noise rejection scheme, but also resolves a technical issue that makes the time-domain formulation possible. By taking the time derivatives of equations (2) and (3), we have

$$\begin{matrix}{i}_{m}^{′} = \frac{d {i}_{m}}{d t} = ω {I}_{m} cos ω t & ( 10 ) \\ {v}_{m}^{′} = \frac{d {v}_{m}}{d t} = ω {V}_{m} cos ( ω t + φ ) & ( 11 )\end{matrix}$$

By substituting equations (10) and (11) into equation (9), we have

x=ωVₘ cos(ωt+φ)−ωRₐIₘ cos ωt (12)

There are 2 unknowns (Rₘ and Cₘ), which require at least 2 independent measurements to resolve. To improve the accuracy, a least-squares estimator is derived by using N sample points. An appropriate choice of N is the number of sample points for one cycle of the sine wave. The inclusion of all samples from a full cycle of excitation ensures accuracy. Equation (8) is rearranged and extended to a matrix form as follows:

$$[ \begin{matrix}{x}_{1} \\ {x}_{2} \\ … \\ {x}_{N}\end{matrix} ] = [ \begin{matrix}{i}_{m 1} & {v}_{m 1} \\ {i}_{m 2} & {v}_{m 2} \\ … & … \\ {i}_{mN} & {v}_{mN}\end{matrix} ] [ \begin{matrix}{θ}_{1} \\ {θ}_{2}\end{matrix} ] or \underline{x} = A \underline{θ} \qquad ( 13 )$$

The plant matrix A is given by

$$A = [ \begin{matrix}{i}_{m 1} & {v}_{m 1} \\ {i}_{m 2} & {v}_{m 2} \\ … & … \\ {i}_{mN} & {v}_{mN}\end{matrix} ] \qquad ( 14 )$$

The measurement vector is given by

$$\underline{x} = [ \begin{matrix}ω {V}_{m} cos ( ω {t}_{1} + φ ) - ω {R}_{a} {I}_{m} cos ω {t}_{1} \\ ω {V}_{m} cos ( ω {t}_{2} + φ ) - ω {R}_{a} {I}_{m} cos ω {t}_{2} \\ … \\ ω {V}_{m} cos ( ω {t}_{N} + φ ) - ω {R}_{a} {I}_{m} cos ω {t}_{N}\end{matrix} ] \qquad ( 15 )$$

The unknown vector is given by

$$\underline{θ} = [ \begin{matrix}{θ}_{1} \\ {θ}_{2}\end{matrix} ] = [ \begin{matrix}\frac{1}{{C}_{m}} + \frac{{R}_{a}}{{R}_{m} {C}_{m}} \\ - \frac{1}{{R}_{m} {C}_{m}}\end{matrix} ] \qquad ( 16 )$$

From equation (14) the electrical properties can be determined as follows:

$$[ \begin{matrix}{R}_{m} \\ {C}_{m}\end{matrix} ] = [ \begin{matrix}- \frac{{θ}_{1}}{{θ}_{2}} - {R}_{a} \\ \frac{1}{{θ}_{1} + {R}_{a} {θ}_{2}}\end{matrix} ] , \qquad ( 17 )$$

where Rₐ is the electrode resistance determined in the initial calibration step. A least-squares estimator of the unknown vector is given by

\hat{θ}=(A^{T}A)⁻¹A^{T}x (18)

A^{T}A is a 2-by-2 matrix, denoted as

$${A}^{T} A = [ \begin{matrix}a & b \\ c & d\end{matrix} ] \qquad ( 19 )$$

The inversion of A^{T}A can easily be computed as follows:

$${( {A}^{T} A )}^{- 1} = \frac{1}{ad - bc} [ \begin{matrix}d & - b \\ - c & a\end{matrix} ] \qquad ( 20 )$$

Equation (12) represents a key component of this invention. Generally speaking, it is not desirable to include the derivative of any measurement in the formulation. This is because taking the derivative of a measured signal is a noisy process. The differentiation would accentuate the high-frequency noise contained in the measurement. However, in this case the drawback is completely overcome by incorporating the concept of the lock-in amplifier. For a linear system, the output in response to a sinusoidal input should also be a sinusoidal wave. Any components other than the sine wave are considered noise and thus eliminated. The derivatives of the sine waves have closed-form solutions, as shown in equations (10) and (11), which do not introduce any additional noise. This time-domain formulation is represented by a set of linear equations, which are much simpler than the frequency-domain formulation as shown in equation (1). The resulting estimation method is a linear least-squares estimator, equation (18), which lends itself to real-time applications with a high temporal resolution.

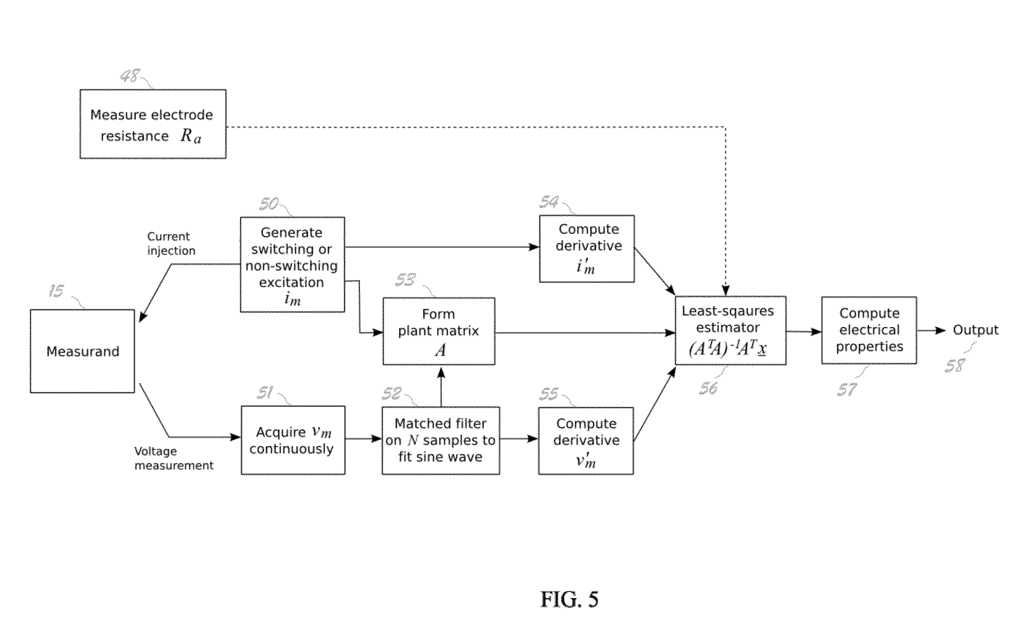

The signal processing is accomplished by use of two algorithms: one algorithm to extract the sinusoidal wave from the induced voltage response and the other to perform the least-squares estimation on the electrical properties. As shown in FIG. 5, the electrode resistance 48 is first determined before applying the electrode to the measurand. This calibration step only needs to be performed once. Then, the electrode is applied to the measurand for repetitive and continuous measurements of the electrical properties. A sinusoidal waveform iₘ 50, either switching or non-switching, is generated and sent to the measurand 15 as an injected current. The sinusoidal envelope is at a frequency off, and ω=2πf. The induced voltage vₘ is continuously digitized and acquired 51. A matched filter 52 is applied to an N-sample segment of vₘ to extract the sinusoidal envelope in terms of its magnitude and phase.

An appropriate choice of N is the number of samples for a full cycle of the sine wave. As an alternative to the matched filter, a Kalman filter can be used to update the magnitude and phase continuously. Then, the plant matrix A is formed 53. The derivatives of iₘ 54 is computed based on equation (10). The derivative of vₘ 55 is computed based on equation (11). A linear least-squares estimation 56 is conducted according to equation (18). The inversion of matrix A^{T}A in real time is computationally manageable on a digital signal processor according to equation (20). The electrical properties 57 are computed based on equation (17). The final output of the system 58 is the electrical properties of the measurand. The output is updated at a frequency f if N is chosen to cover a full sinusoidal cycle.

### REFERENCES

### U.S. Patent Documents

U.S. Pat. No. 4,914,677 T. Yamaguchi, T Nakanishi, N. Arakawa, Y. Takanaga. Digital lock-in amplifier. 1990.
U.S. Pat. No. 5,210,484 P. A. Remillard, M. C. Amorelli. Lock-in amplifier. 1993.
U.S. Pat. No. 7,489,965 B2 Y. Sun, J. Wu, L. P. Collis, R. B. Hill. Apparatus for neuromuscular measurement and control. 2009.
U.S. Pat. No. 8,000,783 B2 Y. Sun, J. Wu, J. DiCecco, R. B. Hill. N. Voltage-current analysis for nerve and muscle tissues. 2011.

### Foreign Patent Documents

EP 0119711 A1 E. A. Faulkner. Lock-in amplifiers. 1984.

### OTHER PUBLICATIONS

Barnett D W, Misler S. An optimized approach to membrane capacitance estimation using dual-frequency excitation. Biophysical J 72(April): 1641-58, 1997.
Debus K, Hartmann J, Kilic G, Lindau M. Influence of conductance changes on patch clamp capacitance measurements using a lock-in amplifier and limitations of the phase tracking technique. Biophys J. 69(6): 2808-22, 1995.
Golowasch J, Thomas G, Taylor A L, Patel, A, Pineda A, Khalil C, Nadim F. Membrane capacitance measurements revisited: dependence of capacitance value on measurement method in nonisopotential neurons. J Neurophysiol 102: 2161-75, 2009.
Lempka S F, Barnett D W. Optimization of multi-frequency techniques used for cell membrane capacitance estimation. Proc. 26th Ann. Int. Conf. IEEE EMBS, San Francisco, Calif., USA, pp. 522-5, Sep. 1-5, 2004.
Rituper B, Gucek A, Jorgacevski J, Flasker A, Kreft M, Zorec R. High-resolution membrane capacitance measurements for the study of exocytosis and endocytosis. Nature Protocols 8(6): 1170-83, 2013.
Thompson R E, Lindau M, Webb W W. Robust, high-resolution, whole cell patch-clamp capacitance measurements using square wave stimulation. Biophysical Journal 81(August):937-948, 2001.

What is claimed is:

1. A method for measuring the electrical properties of a measurand via a single port comprising the steps of
(a) calibrating the system by measuring the electrode resistance,
(b) applying a current injection of a sinusoidally amplitude-modulated switching waveform via a time-multiplexed channel to said measurand,
(c) measuring the induced voltage that is time-multiplexed with the said current from said port via said channel,
(d) estimating the magnitude and the phase of said induced voltage,
(e) forming a circuit model that represents the electrical properties and circuit topology of said measurand,
(f) deriving the time-domain equations that govern the continuity of currents of said circuit model,
(g) computing the derivatives of the injected current and the induced voltage by using closed-form sinusoidal equations,
(h) forming a linear estimator to determine the unknown electrical properties
(i) repeating the above steps in real time to achieve continuous monitoring of the electrical properties of said measurand.

2. The method as claimed in claim 1, wherein said current injection has a non-switching sinusoidal waveform.

3. An apparatus for measuring the electrical properties of a measurand via a single port comprising:
(a) means for calibrating the system by measuring the electrode resistance,
(b) means for applying a current injection of a sinusoidally amplitude-modulated switching waveform via a time-multiplexed channel to said measurand,
(c) means for measuring the induced voltage that is time-multiplexed with the said current from said port via said channel,
(d) means for estimating the magnitude and the phase of said induced voltage,
(e) means for forming a circuit model that represents the electrical properties and circuit topology of said measurand,
(f) means for deriving the time-domain equations that govern the continuity of currents of said circuit model,
(g) means for computing the derivatives of the injected current and the induced voltage by using closed-form sinusoidal equations,
(h) means for forming a linear estimator to determine the unknown electrical properties, and
(i) means for repeating the about steps in real time to achieve continuous monitoring of the electrical properties of said measurand.

4. The apparatus as claimed in claim 2, wherein said current injection has a non-switching sinusoidal waveform.
